(19) United States
(12) Patent Application Publication
(10) Pub. No.: US 2019/0156439 A1
(43) Pub. Date: May 23, 2019

(54) INFORMATION PROCESSING DEVICE, INFORMATION PROCESSING METHOD, AND COMPUTER READABLE MEDIUM

(71) Applicant: Mitsubishi Electric Corporation, Tokyo (JP)

(72) Inventor: Daisuke TAKITA, Tokyo (JP)

(73) Assignee: Mitsubishi Electric Corporation, Tokyo (JP)

(21) Appl. No.: 16/091,355

(22) PCT Filed: May 27, 2016
(86) PCT No.: PCT/JP2016/065813

§ 371 Date: Oct. 4, 2018

(51) Int. Cl. G06Q 50/06; G06Q 30/02

(52) U.S. Cl. CPC G06Q 50/06; G06Q 30/0207; G06Q 30/0283

(57) ABSTRACT

An information acquisition unit acquires operational status information representing operational status of equipment that consumes energy with operation and operational environment information representing an operational environment of the equipment. A determination unit determines whether energy consumption resulting from the operation of the equipment is luxury energy consumption or not, based on the operational status of the equipment that is represented by the operational status information and the operational environment of the equipment that is represented by the operational environment information, and applies an extra price to the energy consumption resulting from the operation of the equipment when the energy consumption resulting from the operation of the equipment is determined to be the luxury energy consumption.

### TECHNICAL FIELD

The present invention relates to an information processing device, an information processing method, and an information processing program.

### BACKGROUND ART

Tax systems are known in which products such as cigarettes and liquors that are deemed luxury or harmful are heavily taxed in order that users may be discouraged from purchasing the products. On the contrary, tax systems are known in which low tax rates are set for daily necessities for low-income protection.

For energy pricing, there are methods in which prices are varied in accordance with energy sources. For instance, renewable energy may be priced inexpensively in order that resource saving may be promoted. Moreover, there are methods in which a price is varied in accordance with balance of supply and demand of energy. For instance, power demand at peak hour may be reduced by demand response.

Patent Literature 1 discloses a method in which a user is surcharged when the user feels comfortable.

### CITATION LIST

### Patent Literature

Patent Literature 1: JP 2004-211954

### SUMMARY OF INVENTION

### Technical Problem

In order to attain energy-saving society, it is needed to reduce luxury energy consumption that is not daily necessary energy consumption.

A charge for current energy consumption is commonly levied in accordance with an amount of the energy consumption. Therefore, the same price is charged for the luxury energy consumption and for the daily necessary energy consumption, provided that the amounts of the energy consumptions are the same. In such a pricing structure that is based only on the amount of energy consumption, it is difficult to reduce the luxury energy consumption.

The present invention is conceived in consideration of such circumstances and mainly aims at effectively reducing the luxury energy consumption.

### Solution to Problem

An information processing device according the present invention, includes:

an information acquisition unit to acquire operational status information representing operational status of equipment that consumes energy with operation and operational environment information representing an operational environment of the equipment; and

a determination unit to determine whether energy consumption resulting from the operation of the equipment is luxury energy consumption or not, based on the operational status of the equipment that is represented by the operational status information and the operational environment of the equipment that is represented by the operational environment information, and to apply an extra price to the energy consumption resulting from the operation of the equipment, when the energy consumption resulting from the operation of the equipment is determined to be the luxury energy consumption.

### Advantageous Effects of Invention

According to the present invention, the luxury energy consumption may be effectively reduced by extraction of the luxury energy consumption and application of the extra price to the extracted luxury energy consumption.

### BRIEF DESCRIPTION OF DRAWINGS

FIG. 1 illustrates a hardware configuration example of a charging determination device according to Embodiment 1.

FIG. 2 illustrates a functional configuration example of the charging determination device according to Embodiment 1.

FIG. 3 is a flowchart illustrating an example of actions of the charging determination device according to Embodiment 1.

FIG. 4 illustrates an example of operational status information according to Embodiment 1.

FIG. 5 illustrates an example of operational environment information according to Embodiment 1.

FIG. 6 illustrates an example of charging rules according to Embodiment 1.

FIG. 7 illustrates an example of operational status information according to Embodiment 1.

FIG. 8 illustrates an example of operational environment information according to Embodiment 1.

FIG. 9 illustrates an example of charging rules according to Embodiment 1.

FIG. 10 illustrates an example of operational status information according to Embodiment 1.

FIG. 11 illustrates an example of operational environment information according to Embodiment 1.

FIG. 12 illustrates an example of charging rules according to Embodiment 1.

### DESCRIPTION OF EMBODIMENTS

### Embodiment 1

As for the present embodiment, a description will be given on a charging determination device, for users of equipment which is operated by energy such as electricity or gas, that determines luxuriousness of effects obtained from use of the equipment and that calculates a price to be imposed, based on the luxuriousness.

The charging determination device according to the present embodiment applies an extra price to luxury energy consumption that provides excessive utility for the users of the equipment. The charging determination device may apply a discount price to daily necessary energy consumption for obtainment of reasonable utility by the users of the equipment.

***Description on Configurations***

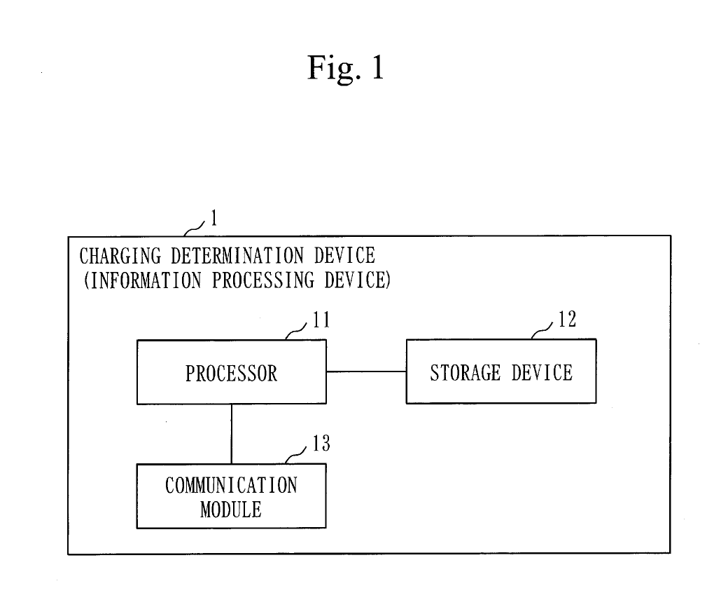

FIG. 1 illustrates a hardware configuration example of the charging determination device 1 according to the present embodiment.

The charging determination device 1 corresponds to an information processing device. Actions that are carried out by the charging determination device 1 correspond to an information processing method.

As illustrated in FIG. 1, the charging determination device 1 is a computer that includes a processor 11, a storage device 12, and a communication module 13, as hardware.

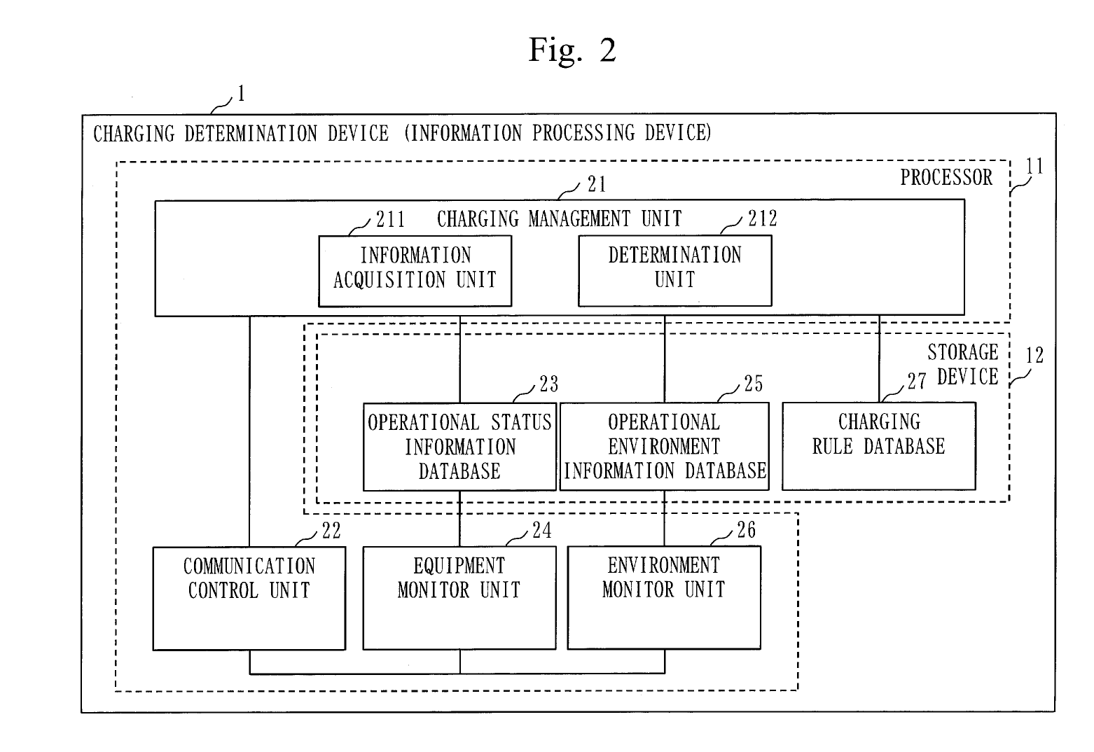

In the storage device 12, programs that fulfil functions of a charging management unit 21, a communication control unit 22, an equipment monitor unit 24, and an environment monitor unit 26, which are illustrated in FIG. 2, are stored.

By executing the programs, the processor 11 carries out actions of the charging management unit 21, the communication control unit 22, the equipment monitor unit 24, and the environment monitor unit 26 that will be described later.

FIG. 1 schematically illustrates a state in which the processor 11 executes the programs that fulfil the functions of the charging management unit 21, the communication control unit 22, the equipment monitor unit 24, and the environment monitor unit 26, that is, a state in which the processor 11 acts as the charging management unit 21, the communication control unit 22, the equipment monitor unit 24, and the environment monitor unit 26. In particular, the program that fulfils the functions of the charging management unit 21 corresponds to the information processing program.

The storage device 12 implements an operational status information database 23, the equipment monitor unit 24, and the environment monitor unit 26 that are illustrated in FIG. 2.

The communication module 13 is a circuit that communicates with externals of the charging determination device 1 through a communications network such as wired LAN (Local Area Network) or wireless LAN.

FIG. 2 illustrates a functional configuration example of the charging determination device 1 according to the present embodiment.

The charging management unit the charging management unit 21 determines an amount of charging to a user of energy, based on information in the operational status information database 23, information in an operational environment information database 25, and information in a charging rule database 27, which will be described later, and notifies an external charging system of the determined amount of charging.

The charging management unit 21 is composed of an information acquisition unit 211 and a determination unit 212.

The information acquisition unit 211 acquires operational status information from the operational status information database 23, acquires operational environment information from the equipment monitor unit 24, and acquires charging rules from the charging rule database 27.

The operational status information represents operational status of equipment that consumes energy with operation.

The operational environment information represents an operational environment of the equipment.

The charging rules represent a definition of the luxury energy consumption and a charging rate that is applied in case where energy consumption in the equipment comes under the luxury energy consumption.

Actions that are carried out by the information acquisition unit 211 correspond to the information acquisition process.

The determination unit 212 determines whether the energy consumption resulting from operation of the equipment is the luxury energy consumption or not, based on the operational status of the equipment that is represented by the operational status information, the operational environment of the equipment that is represented by the operational environment information, and the charging rules. When the determination unit 212 determines that the energy consumption resulting from the operation of the equipment is the luxury energy consumption, the determination unit 212 applies the extra price to the energy consumption resulting from the operation of the equipment.

Actions that are carried out by the determination unit 212 correspond to the determination process.

The communication control unit 22 executes a communication protocol and thereby communicates with the externals of the charging determination device 1. For instance, the communication control unit 22 communicates with an external charging system.

The operational status information database 23 stores the operational status information.

The operational status information indicates a model number, an operation mode, an application, setting values, an action history, and the like of the equipment that consumes energy.

The equipment monitor unit 24 collects the operational status information by monitoring the equipment and stores the collected operational status information in the operational status information database 23.

The operational environment information database 25 stores the operational environment information.

The operational environment information represents an environment, such as an outside air temperature and a number of people being in a room, in which the equipment is installed.

The environment monitor unit 26 collects the operational environment information by monitoring the environment in which the equipment is installed and stores the collected operational environment information in the operational environment information database 25.

The charging rule database 27 stores the charging rules.

As described above, the charging rules represent the definition of the luxury energy consumption (conditions that cause charging, in other words) and the charging rate.

***Description on Actions***

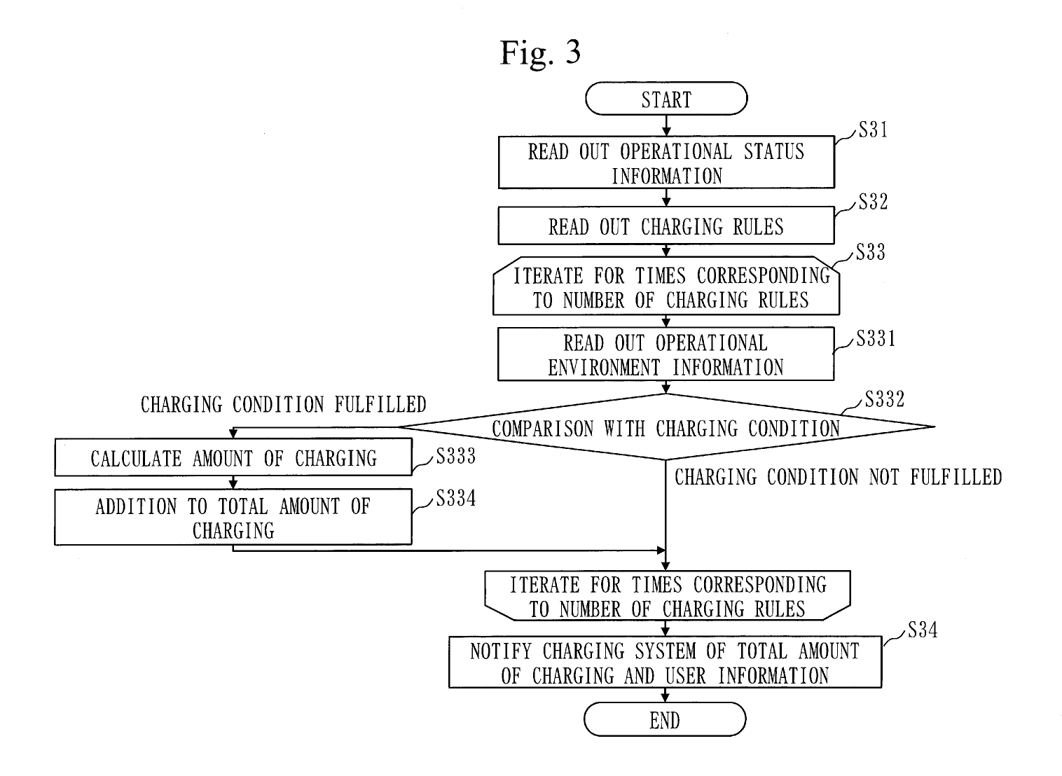

With use of FIG. 3, subsequently, an example of actions of the charging management unit 21 will be described.

In step S31, initially, the information acquisition unit 211 reads out the operational status information on the equipment to be subjected to determination, from the operational status information database 23.

In step S32, subsequently, the information acquisition unit 211 reads out all charging rules for the equipment to be subjected to the determination, from the charging rule database 27.

In step S33, subsequently, processes of step S331 and later steps except step S34 are iterated for times corresponding to the number of the charging rules read out in step S32.

In step S331, the information acquisition unit 211 reads out all the operational environment information relating to the equipment to be subjected to the determination and the charging rules that are currently used for the determination, from the operational environment information database 25.

In step S332, the determination unit 212 compares the operational status information read out in step S31 and the operational environment information read out in step S331, with the charging conditions of the charging rules read out in step S32.

When the charging conditions of the charging rules are fulfilled in step S332, that is, when the energy consumption resulting from the operation of the equipment is the luxury energy consumption, the determination unit 212 decides to apply the charging rate of the charging rules. That is, the determination unit 212 decides to apply the extra price to the energy consumption resulting from the operation of the equipment.

In step S333, the determination unit 212 calculates the amount of charging as the extra price, based on the charging rate of the charging rules.

In step S334, the determination unit 212 adds the amount of charging, calculated in step S33, to a total amount of charging.

The total amount of charging is sum of the amount of charging, calculated based on the amount of energy consumption, and the amounts of charging that have been calculated in step S333 up to that point, for instance.

In step S34, finally, the determination unit 212 notifies the charging system of the total amount of charging, acquired in step S334, and information on a user through the communication control unit 22.

Above actions of the charging management unit 21 will be described with use of a specific example.

### Specific Example 1

Herein, an example in which the equipment is air conditioning equipment for building (which will be referred to as building air conditioning equipment, hereinbelow) will be described.

In the present example, the determination unit 212 matches an indoor air temperature, an outside air temperature, and the number of people being in the room, with the charging rules. In case of excessive cooling or excessive heating, that is, in case where the energy consumption resulting from operation of the building air conditioning equipment is the luxury energy consumption, the determination unit 212 decides to apply the extra price.

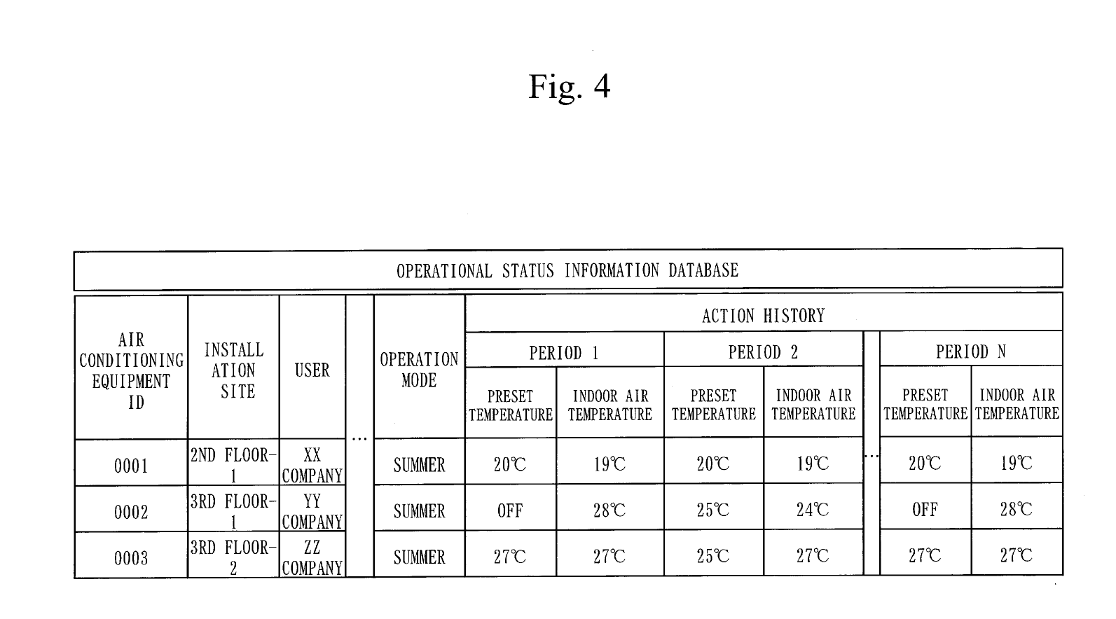

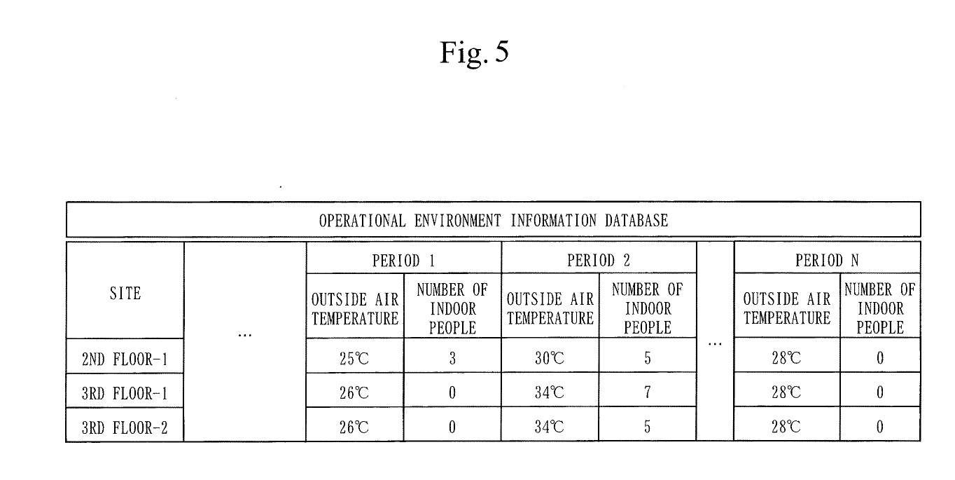

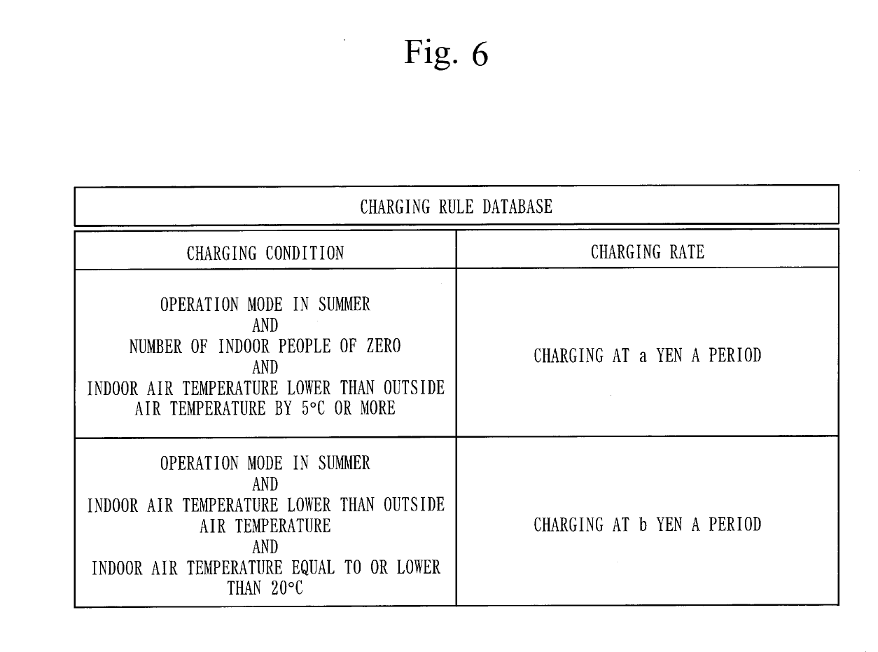

FIG. 4 illustrates the operational status information in the example in which the equipment is the building air conditioning equipment. FIG. 5 illustrates the operational environment information in the example in which the equipment is the building air conditioning equipment. FIG. 6 illustrates charging rules in the example in which the equipment is the building air conditioning equipment.

The operational status information of FIG. 4 includes information such as an air conditioning equipment ID (Identifier), an installation site, a user, an operation mode, and an action history of each building air conditioning equipment.

The air conditioning equipment ID and the installation site are information that identifies the building air conditioning equipment and the installation site thereof. The installation site is a room where the building air conditioning equipment is installed.

The user indicates the user of the building air conditioning equipment to be charged.

The operation mode indicates the operation mode of the building air conditioning equipment. Specifically, the operation modes include a summer mode in which cooling is used and a winter mode in which heating is used.

The action history indicates a history of past actions of the building air conditioning equipment. Specifically, the action history indicates a preset temperature and the indoor air temperature in each unit period. The preset temperature is a temperature set for the building air conditioning equipment. The indoor air temperature is an indoor air temperature of the room where the building air conditioning equipment is installed.

The equipment monitor unit 24 carries out numerical processes such as averaging, maximum acquisition, and minimum acquisition for values acquired from each building air conditioning equipment. The values after the equipment monitor unit 24 has carried out the numerical processes are stored as the operational status information in the operational environment information database 25.

The operational environment information of FIG. 5 represents the operational environment of each installation site (room) of the building air conditioning equipment.

More specifically, the operational environment information of FIG. 5 represents the outside air temperature and the number of people being in the installation site (number of indoor people) in each unit period. The unit period of FIG. 5 corresponds to the unit period of the action history in the operational status information of FIG. 4.

The outside air temperature is the outside air temperature of the room where the building air conditioning equipment is installed. The outside air temperature is acquired by a temperature sensor. The number of indoor people is the number of people being in the room in which the building air conditioning equipment is installed. The number of indoor people is acquired by a human presence sensor, an entrance and exit control system, or the like.

The environment monitor unit 26 carries out numerical processes such as the averaging, the maximum acquisition, and the minimum acquisition for values acquired from the sensors or the like. The values after the environment monitor unit 26 has carried out the numerical processes are stored as the operational status information in the operational environment information database 25.

The charging rules of FIG. 6 include the charging condition and the charging rate.

The charging condition is a conditional expression in which items included in the operational status information and items included in the operational environment information are combined. Energy consumption that fits the charging condition is the luxury energy consumption. Therefore, the extra price is applied to the energy consumption that fits the charging conditions.

The charging rate is an expression for deciding of the amount of charging in a case where the extra price is applied.

The amount of charging may have a negative value. A positive amount of charging denotes an additional amount of charging for the amount of charging calculated based on the amount of energy consumption and a negative amount of charging denotes a deduction from the amount of charging calculated based on the amount of energy consumption.

Thus the determination unit 212 makes a determination on luxuriousness with reference to the operational status and the operational environment of the equipment and decides the amount of charging in accordance with a result of the determination. As a result, an additional charge may be levied on a tenant that excessively uses the air conditioning equipment though no people exist in the room, a tenant that excessively uses the air conditioning equipment for the outside air temperature, or the like.

### Specific Example 2

Subsequently, an example in which the equipment is a lighting system will be described. The lighting system includes one or more illuminators and the one or more illuminators are installed in a room.

In the present example, the determination unit 212 matches the number of people being in the room, lighting-up or lights-out status of the illuminators, and an illuminance in the room, with charging rules. In case where the illuminators are unnecessarily lighted up, that is, in case where energy consumption resulting from operation of the lighting system is the luxury energy consumption, the determination unit 212 decides to apply an extra price.

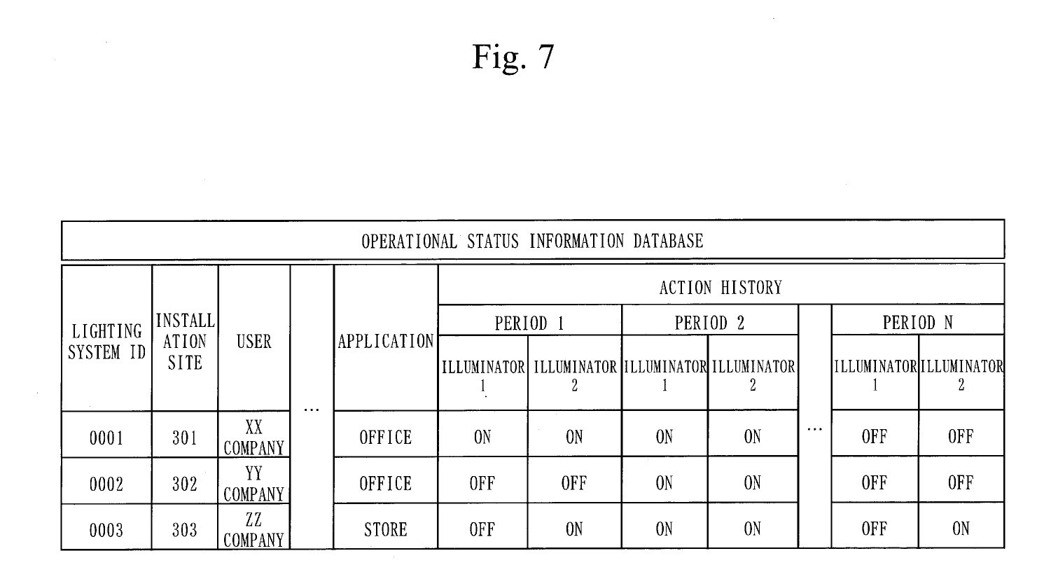

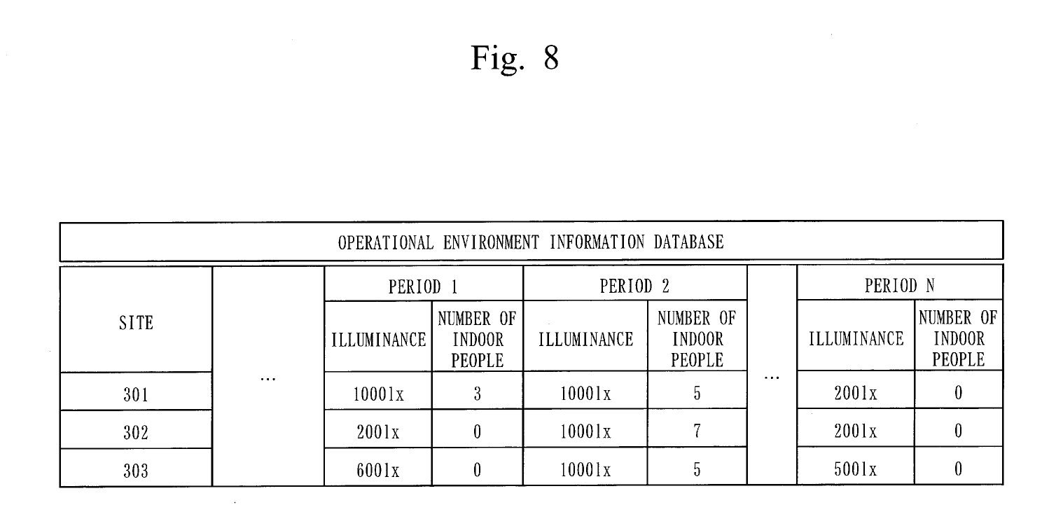

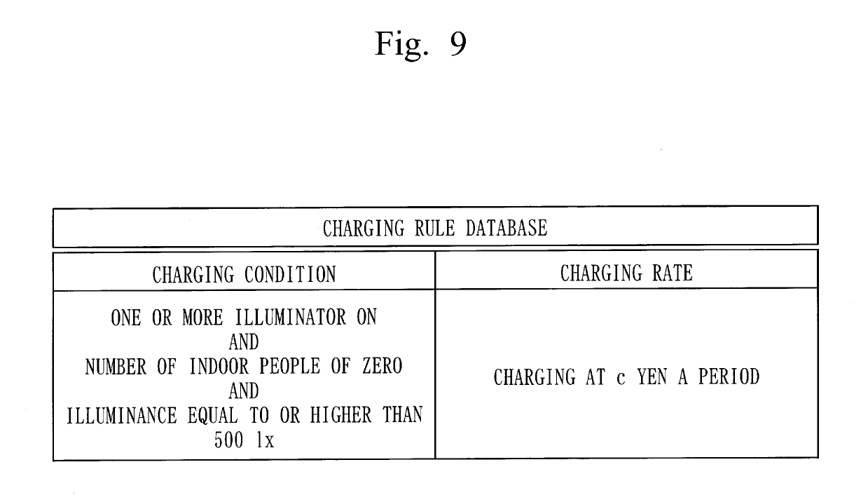

FIG. 7 illustrates the operational status information in an example in which the equipment is the lighting system. FIG. 8 illustrates the operational environment information in the example in which the equipment is the lighting system. FIG. 9 illustrates the charging rules in the example in which the equipment is the lighting system.

The operational status information of FIG. 7 includes information such as a lighting system ID, an installation site, a user, an application, and an action history of each lighting system.

The lighting system ID and the installation site are information that identifies the lighting system and the installation site thereof. The installation site is the room where the lighting system is installed.

The user indicates a user of the lighting system to be charged.

The application indicates an application of the installation site of the lighting system.

The action history indicates a history of past actions of the lighting system. Specifically, the action history indicates the lighting-up or lights-out status of the illuminators in each unit period. FIG. 7 illustrates the example in which two illuminators are installed in each room. A description of “ON” indicates lighting-up of the illuminator. A description of “OFF” indicates lights-out of the illuminator.

The equipment monitor unit 24 carries out numerical processes such as the averaging, the maximum acquisition, and the minimum acquisition for values acquired from each lighting system. The values after the equipment monitor unit 24 has carried out the numerical processes are stored as the operational status information in the operational environment information database 25.

The operational environment information of FIG. 8 represents an operational environment of each installation site (room) of the lighting system.

More specifically, the operational environment information of FIG. 8 represents the illuminance and the number of people being in the installation site (number of indoor people) in each unit period. The unit period of FIG. 8 corresponds to the unit period of the action history in the operational status information of FIG. 7.

The illuminance is an illuminance of the room where the lighting system is installed. The illuminance is acquired by an illuminance sensor. The number of indoor people is the number of people being in the room in which the lighting system is installed. The number of indoor people is acquired by a human presence sensor, an entrance and exit control system, or the like.

The environment monitor unit 26 carries out numerical processes such as the averaging, the maximum acquisition, and the minimum acquisition for values acquired from sensors or the like. The values after the environment monitor unit 26 has carried out the numerical processes are stored as the operational status information in the operational environment information database 25.

The charging rules of FIG. 9 also include the charging condition and the charging rate, as with the charging rules of FIG. 6.

The charging condition of FIG. 9 is defined by the lighting-up or lights-out status of the illuminators, the number of indoor people, and the illuminance.

A role of the charging rules of FIG. 9 is the same as a role of the charging rules of FIG. 6.

In the present example, an additional charge may be levied on a tenant that excessively uses the lighting system in status in which no people exist in the room and with an illuminance exceeding a minimum illuminance required for such a purpose as crime prevention.

### Specific Example 3

Subsequently, an example in which the equipment is an air conditioner that is mounted on a vehicle (which will be referred to as vehicle air conditioning equipment, hereinbelow) will be described.

In the present example, the determination unit 212 matches an air temperature on inside of the vehicle and an air temperature on outside of the vehicle, with the charging rules. In case where the vehicle air conditioning equipment is used more than necessary, that is, in case where energy consumption resulting from operation of the vehicle air conditioning equipment is the luxury energy consumption, the determination unit 212 decides to apply an extra price.

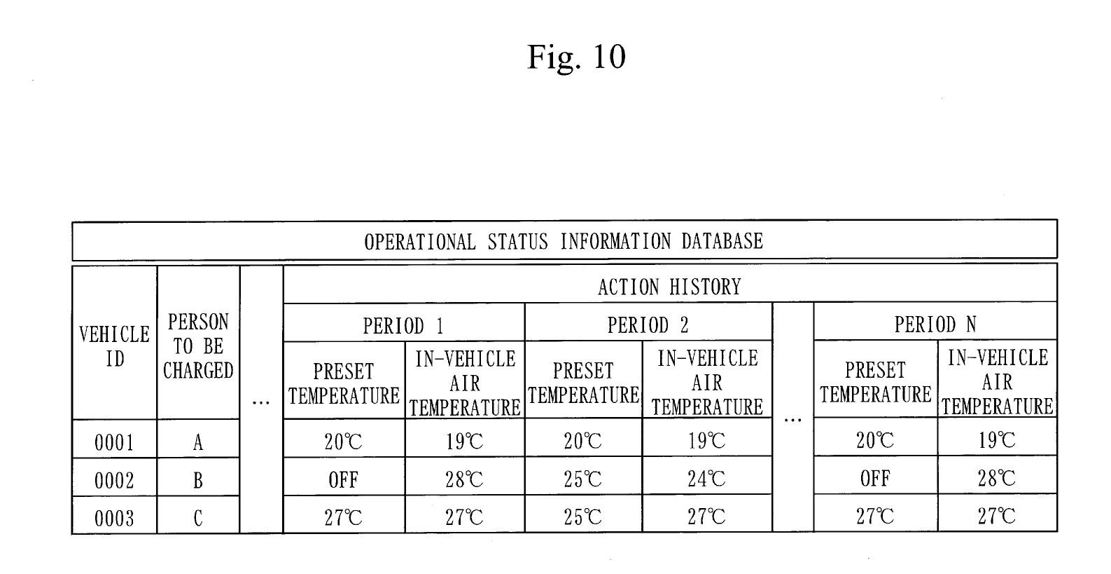

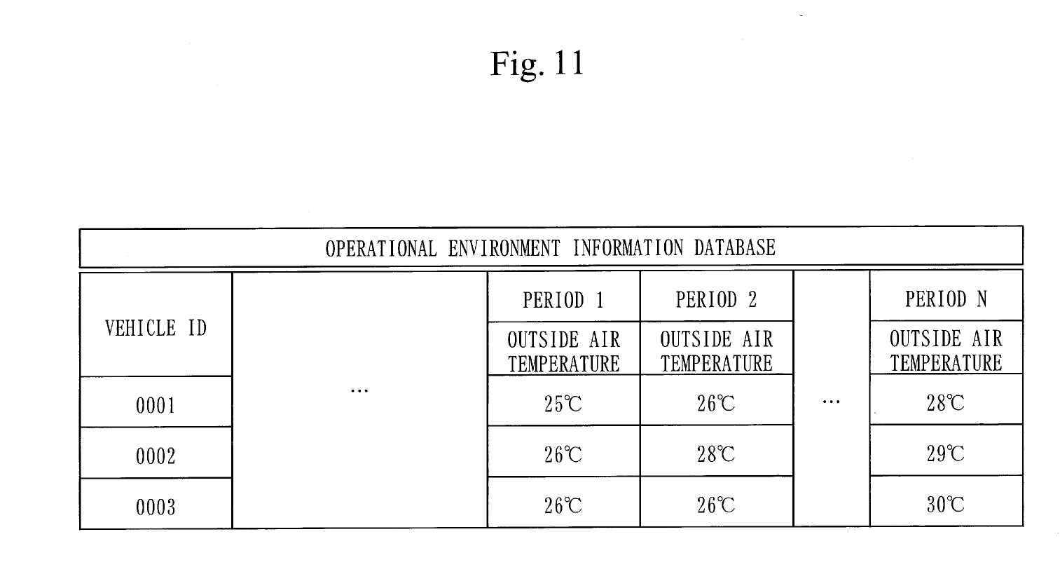

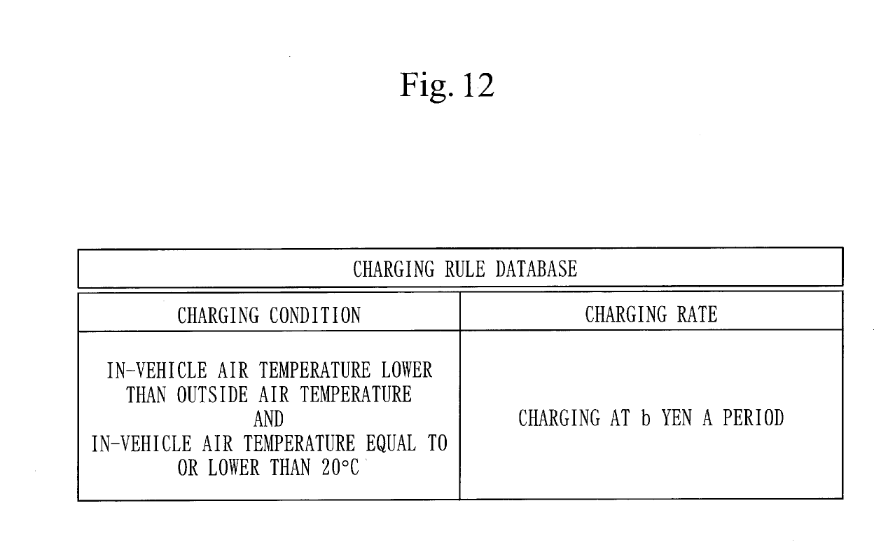

FIG. 10 illustrates the operational status information in the example in which the equipment is the vehicle air conditioning equipment. FIG. 11 illustrates the operational environment information in the example in which the equipment is the vehicle air conditioning equipment. FIG. 12 illustrates charging rules in the example in which the equipment is the vehicle air conditioning equipment.

The operational status information of FIG. 10 includes information such as a vehicle ID, a person to be charged, and an action history of each vehicle on which the vehicle air conditioning equipment is mounted.

The vehicle ID is information that identifies the vehicle on which the vehicle air conditioning equipment is mounted.

The person to be charged indicates a person who is a subject of charging. The person to be charged may be an owner of the vehicle, a holder of a credit card inserted into on-board equipment for electronic toll collection system that is installed on the vehicle, or the like.

The action history indicates a history of past actions of the vehicle air conditioning equipment. Specifically, the action history indicates a preset temperature and an in-vehicle air temperature in each unit period. The preset temperature is a temperature set for the vehicle air conditioning equipment. The in-vehicle air temperature is the air temperature in the vehicle.

The equipment monitor unit 24 carries out numerical processes such as the averaging, the maximum acquisition, and the minimum acquisition for values acquired from each vehicle air conditioning equipment. The values after the equipment monitor unit 24 has carried out the numerical processes are stored as the operational status information in the operational environment information database 25.

The operational environment information of FIG. 11 represents an operational environment of each vehicle in which the vehicle air conditioning equipment is mounted.

More specifically, the operational environment information of FIG. 11 represents an outside air temperature in each unit period. The unit period of FIG. 11 corresponds to the unit period of the action history in the operational status information of FIG. 10.

The outside air temperature is the outside air temperature of the vehicle. The outside air temperature is acquired by a temperature sensor.

The environment monitor unit 26 carries out numerical processes such as the averaging, the maximum acquisition, and the minimum acquisition for values acquired from the temperature sensor. The values after the environment monitor unit 26 has carried out the numerical processes are stored as the operational status information in the operational environment information database 25.

The charging rules of FIG. 12 also include the charging condition and the charging rate, as with the charging rules of FIG. 6.

The charging condition of FIG. 12 is defined by the in-vehicle air temperature and the outside air temperature.

A role of the charging rules of FIG. 12 is the same as the role of the charging rules of FIG. 6.

In the present example, the charging determination device 1 may be placed in the vehicle. Specifically, a computer that carries out the processes of the charging determination device 1 may be placed in the vehicle or a computer mounted in the vehicle may be made to carry out the processes of the charging determination device 1. In general, a vehicle carries out communications with externals with use of mobile communication, an electronic toll collection system, or the like and thus may be restricted in opportunities of communication. In such a case, an effect of reducing communications traffic may be gained by placement of the charging determination device 1 in the vehicle. On condition that the charging determination device 1 is placed in the vehicle, the equipment monitor unit 24 is capable of acquiring a value of the preset temperature from the vehicle air conditioning equipment, acquiring the in-vehicle air temperature from the temperature sensor that collects the in-vehicle air temperature, and storing the acquired values in the operational status information database 23. The environment monitor unit 26 is capable of acquiring an out-of-vehicle air temperature from the temperature sensor that collects the out-of-vehicle air temperature and storing the acquired value in the operational environment information database 25. The charging management unit 21 is capable of transmitting the total amount of charging calculated under a procedure illustrated in FIG. 3 and user information (information indicating the person to be charged illustrated in FIG. 10) through the equipment monitor unit 24 to the charging system when information relating to charging of a toll is transmitted to the electronic toll collection system.

In the present example, a charge may be levied on a person who excessively uses the vehicle air conditioning equipment for the outside air temperature.

Though the examples in which the determination unit 212 decides to apply the extra price to the luxury energy consumption have been described above, the determination unit 212 may decide to apply a discount price to the daily necessary energy consumption.

In this case, conditions for application of the discount price, that is, a definition of the daily necessary energy is described in a field of the charging conditions of the charging rules. As the charging rate, a rate of the discount price is described. The determination unit 212 applies the discount price to the daily necessary energy consumption in accordance with the charging rules.

***Description on Effects of Embodiment***

According to the present embodiment, the luxury energy consumption may be effectively reduced by extraction of the luxury energy consumption and application of the extra price to the extracted luxury energy consumption.

According to the present embodiment, a burden of the price for the daily necessary energy consumption may be reduced by extraction of the daily necessary energy consumption and application of the discount price to the extracted daily necessary energy consumption.

***Description on Hardware Configuration***

Finally, supplementary description on the hardware configuration of the charging determination device 1 will be given.

The processor 11 illustrated in FIG. 1 is an IC (Integrated Circuit) that carries out processing.

The processor 11 is a CPU (Central Processing Unit), a DSP (Digital Signal Processor), or the like.

The storage device 12 illustrated in FIG. 1 is a RAM (Random Access Memory), a ROM (Read Only Memory), a flash memory, an HDD (Hard Disk Drive), or the like.

The communication module 13 illustrated in FIG. 3 includes a receiver that receives data and a transmitter that transmits data.

The communication module 13 is a communication chip or an NIC (Network Interface Card), for instance.

An OS (Operating System) is also stored in the storage device 12.

At least a portion of the OS is executed by the processor 11.

While executing at least the portion of the OS, the processor 11 executes the programs that fulfil the functions of the charging management unit 21, the communication control unit 22, the equipment monitor unit 24, and the environment monitor unit 26 (which will be collectively referred to as the “units”, hereinbelow). The processor 11 executes the OS, so that task management, memory management, file management, communication control, and the like are carried out.

The charging determination device 1 may include a plurality of processors that substitute for the processor 11. Execution of the programs that fulfil the functions of the “units” is shared by the plurality of processors. Each of the processors is an IC that carries out processing as with the processor 11.

Information, data, signal values, variable values, and the like that indicate results of processing in the “units” are stored in at least any of the storage device 12 and a register and a cache memory in the processor 11.

The programs that fulfil the functions of the “units” may be stored in a portable storage medium such as a magnetic disk, a flexible disk, an optical disk, a compact disk, a Blu-ray (a registered trademark) disk, or a DVD.

The “units” may be read as “circuits”, “steps”, “procedures”, or “processing”.

The charging determination device 1 may be implemented by an electronic circuit such as a logic IC (Integrated Circuit), a GA (Gate Array), an ASIC (Application Specific Integrated Circuit), or an FPGA (Field-Programmable Gate Array).

In this case, the “units” are each implemented as a portion of the electronic circuit.

The processor and the electronic circuits may be collectively referred to as processing circuitry.

### REFERENCE SIGNS LIST

1: charging determination device; 11: processor; 12: storage device; 13: communication module; 21: charging management unit; 22: communication control unit; 23: operational status information database; 24: equipment monitor unit; 25: operational environment information database; 26: environment monitor unit; 27: charging rule database; 211: information acquisition unit; 212: determination unit.

1.-8. (canceled)

9. An information processing device comprising:
processing circuitry to:
acquire operational status information representing operational status of air conditioning equipment that carries out air conditioning for a room and operational environment information representing an operational environment of the air conditioning equipment; and
determine whether energy consumption resulting from operation of the air conditioning equipment is luxury energy consumption or not, based on an indoor air temperature of the room that is the operational status of the air conditioning equipment that is represented by the operational status information and an outside air temperature of the room and the number of people being in the room that are the operational environment of the air conditioning equipment that is represented by the operational environment information, and apply an extra price to the energy consumption resulting from the operation of the air conditioning equipment, when the energy consumption resulting from the operation of the air conditioning equipment is determined to be the luxury energy consumption.

10. The information processing device according to claim 9, wherein
the processing circuitry
determines whether the energy consumption resulting from the operation of the air conditioning equipment is necessary energy consumption or not, and
applies a discount price to the energy consumption resulting from the operation of the air conditioning equipment when the energy consumption resulting from the operation of the air conditioning equipment is determined to be the necessary energy consumption.

11. An information processing device comprising:
processing circuitry to:
acquire operational status information representing operational status of a lighting system which includes one or more illuminators and in which the one or more illuminators are installed in a room and operational environment information representing an operational environment of the lighting system; and
determine whether energy consumption resulting from operation of the lighting system is luxury energy consumption or not, based on lighting-up or lights-out status of each of the one or more illuminators that is the operational status of the lighting system that is represented by the operational status information and an illuminance of the room and the number of people being in the room that are the operational environment of the lighting system that is represented by the operational environment information, and apply an extra price to the energy consumption resulting from the operation of the lighting system, when the energy consumption resulting from the operation of the lighting system is determined to be the luxury energy consumption.

12. The information processing device according to claim 11, wherein
the processing circuitry
determines whether the energy consumption resulting from the operation of the lighting system is necessary energy consumption or not, and
applies a discount price to the energy consumption resulting from the operation of the lighting system when the energy consumption resulting from the operation of the lighting system is determined to be the necessary energy consumption.

13. An information processing method comprising:
acquiring operational status information representing operational status of air conditioning equipment that carries out air conditioning for a room and operational environment information representing an operational environment of the air conditioning equipment; and
determining whether energy consumption resulting from operation of the air conditioning equipment is luxury energy consumption or not, based on an indoor air temperature of the room that is the operational status of the air conditioning equipment that is represented by the operational status information and an outside air temperature of the room and the number of people being in the room that are the operational environment of the air conditioning equipment that is represented by the operational environment information, and applying an extra price to the energy consumption resulting from the operation of the air conditioning equipment, when the energy consumption resulting from the operation of the air conditioning equipment is determined to be the luxury energy consumption.

14. An information processing method comprising:
acquiring operational status information representing operational status of a lighting system which includes one or more illuminators and in which the one or more illuminators are installed in a room and operational environment information representing an operational environment of the lighting system; and
determining whether energy consumption resulting from operation of the lighting system is luxury energy consumption or not, based on lighting-up or lights-out status of each of the one or more illuminators that is the operational status of the lighting system that is represented by the operational status information and an illuminance of the room and the number of people being in the room that are the operational environment of the lighting system that is represented by the operational environment information, and applying an extra price to the energy consumption resulting from the operation of the lighting system, when the energy consumption resulting from the operation of the lighting system is determined to be the luxury energy consumption.

15. A non-transitory computer readable medium storing an information processing program that causes a computer to execute:
an information acquisition process of acquiring operational status information representing operational status of air conditioning equipment that carries out air conditioning for a room and operational environment information representing an operational environment of the air conditioning equipment; and
a determination process of determining whether energy consumption resulting from operation of the air conditioning equipment is luxury energy consumption or not, based on an indoor air temperature of the room that is the operational status of the air conditioning equipment that is represented by the operational status information and an outside air temperature of the room and the number of people being in the room that are the operational environment of the air conditioning equipment that is represented by the operational environment information, and applying an extra price to the energy consumption resulting from the operation of the air conditioning equipment, when the energy consumption resulting from the operation of the air conditioning equipment is determined to be the luxury energy consumption.

16. A non-transitory computer readable medium storing an information processing program that causes a computer to execute:
an information acquisition process of acquiring operational status information representing operational status of a lighting system which includes one or more illuminators and in which the one or more illuminators are installed in a room and operational environment information representing an operational environment of the lighting system; and
a determination process of determining whether energy consumption resulting from operation of the lighting system is luxury energy consumption or not, based on lighting-up or lights-out status of each of the one or more illuminators that is the operational status of the lighting system that is represented by the operational status information and an illuminance of the room and the number of people being in the room that are the operational environment of the lighting system that is represented by the operational environment information, and apply an extra price to the energy consumption resulting from the operation of the lighting system, when the energy consumption resulting from the operation of the lighting system is determined to be the luxury energy consumption.
